(19) United States
(12) Patent Application Publication
(10) Pub. No.: US 2013/0018495 A1
(43) Pub. Date: Jan. 17, 2013

(54) METHOD AND APPARATUS FOR PROVIDING CONTENT TO AN EARPIECE IN ACCORDANCE WITH A PRIVACY FILTER AND CONTENT SELECTION RULE

(71) Applicants: Markku Oksanen, Helsinki (FI); Harald Kaaja, Jarvenpaa (FI); Juha-Pekka Luoma, Tampere (FI); Jussi Ruutu, Espoo (FI)

(72) Inventors: Markku Oksanen, Helsinki (FI); Harald Kaaja, Jarvenpaa (FI); Juha-Pekka Luoma, Tampere (FI); Jussi Ruutu, Espoo (FI)

(73) Assignee: NOKIA CORPORATION, Espoo (FI)

(21) Appl. No.: 13/182,032

(22) Filed: Jul. 13, 2011

(51) Int. Cl. G06F 17/00

(52) U.S. Cl. 700/94

(57) ABSTRACT

Methods, apparatus and computer program products provide an improved technique for downloading or otherwise providing content to an earpiece. In this regard, a method may be provided that includes determining a privacy filter and content selection rules associated with an earpiece. The method may also cause content to be provided to the earpiece in accordance with the privacy filter and the content selection rules for storage by the earpiece. The content may be caused to be provided in advance of playback by the earpiece so as to allow for storage of the content by the earpiece. The method may also include causing control signals to be subsequently provided to the earpiece during playback.

### TECHNOLOGICAL FIELD

An example embodiment of the present invention relates generally to the provision of content to an earpiece and, more particularly, to the provision of content to an earpiece in accordance with a privacy filter and content selection rules.

### BACKGROUND

Content must frequently be downloaded or provided from a source device to a recipient device at which the content will be rendered, such as by being played. The downloading of content from a content source device to a recipient device may take into account storage costs as well as the costs associated with the transmission of the content. Although storage costs have generally been reduced over the past few years, there may still be costs associated with the transmission of the content that are not insignificant, if not for the parties involved in the transmission, at least for the transmission network in terms of the resources consumed during the downloading of the content. These transmission costs may be most notable during streaming of the content in an active mode, such upon a request by the receiving device to download and immediately playback the content since such a request may occur at times at which the network is more fully utilized which may result increased costs associated with the transmission of the content, at least for the network.

In addition to cost, the streaming of content for immediate playback by a receiving device, such as an earpiece, may have other challenges. For example, in an instance in which content is streamed via a wireless connection, such as Bluetooth link, from the content source device, such as a mobile terminal, to an earpiece, the streaming of the content may consume substantial battery power of the mobile terminal and the earpiece. In this regard, the streaming of the content generally requires the radios, such as the radio transmitter of the mobile terminal and the radio receiver of the earpiece, to remain active to support the continuous stream of data packets which, in turn, consumes power.

Additionally, the streaming of content for immediate playback by the receiving device, such as an earpiece, may also suffer from transmission errors in the downloading of the content. In instances in which a transmission error occurs, the user of the receiving device may experience unexpected pauses in the playback of the content because of buffer underflow at the receiving device. In this regard, the interruption in the downloading of the content due to a transmission error may extend for a greater period of time than that which may be filled by the playback of content previously stored in the buffer of the receiving device, thereby creating an unexpected pause in the playback of the content. Once streaming of the content recommences, the playback of the content may similarly begin again, albeit following the unexpected pause. In one scenario in which the content includes audio content that experiences an unexpected transmission error, the playback of the audio content following resumption of the streaming of the audio content may be performed at an increased playback rate and sound pitch that will continue until the audio content had eliminated the time lag attributable to the unexpected pause in the streaming of the audio content. Unfortunately, the unexpected pauses and the resulting changes in playback rate and sound pitch may reduce the user experience.

### BRIEF SUMMARY

Methods, apparatus and computer program products are provided in accordance with an example embodiment in order to provide an improved technique for downloading or otherwise providing content to an earpiece. In this regard, content may be provided to the earpiece in advance of playback and in accordance with privacy filter and content selection rules. The content may, in turn, be stored by the earpiece and made available for playback. By downloading or otherwise providing the content in advance of playback, the content may be provided in a manner that minimizes or otherwise reduces the costs associated with the transmission of the content and the storage of the content by the earpiece in advance of playback may eliminate unexpected pauses in the rendering of the content due to transmission errors since any transmission errors would have already been accommodated during the prior receipt and storage of the content.

In one embodiment, a method is provided that includes determining a privacy filter and content selection rules associated with an earpiece. The method may also cause content to be provided to the earpiece in accordance with the privacy filter and the content selection rules for storage by the earpiece. In this regard, content may be caused to be provided in advance of playback by the earpiece so as to allow for storage of the content by the earpiece. The method may also include causing control signals to be subsequently provided to the earpiece during playback.

The method of one embodiment may also include authenticating the earpiece prior to determining the privacy filter and content selection rules. In this embodiment, the determination of the privacy filter may include determining the privacy filter to allow provision of public content, but not private content, to the earpiece in an instance in which the earpiece is not authenticated. Conversely, in an instance in which the earpiece is authenticated, the privacy filter may allow both public content and private content to be provided to the earpiece. The method of one embodiment may also suspend a connection with the earpiece following the provision of the content to the earpiece, thereby conserving battery resources and reducing network resource consumption.

In another embodiment, an apparatus is provided that includes at least one processor and at least one memory including computer program code configured to, with the at least one processor, cause the apparatus to determine a privacy filter and content selection rules associated with an earpiece. The memory including the computer program code may also be configured to, with the at least one processor, cause the apparatus to cause content to be provided to the earpiece, such as an advance of playback of the content, in accordance with the privacy filter and the content selection rules for storage by the earpiece. The memory including the computer program code may also be configured to, with the at least one processor, cause the apparatus to cause control signals to be subsequently provided to the earpiece during playback.

The memory including the computer program product of one embodiment may also include computer program code that is configured to, with the at least one processor, cause the apparatus to authenticate the earpiece prior to determining the privacy filter and the content selection rules. In this embodiment, the at least one memory including the computer program code is configured to, with the at least one processor, cause the apparatus to determine the privacy filter to allow provision of public content, but not private content, in an instance in which the earpiece is not authenticated, but to allow provision of both public content and private content in an instance in which the earpiece is authenticated. The at least one memory including computer program code may be further configured to, with the at least one processor, cause the apparatus of one embodiment to suspend a connection with the earpiece following provision of the content to the earpiece, thereby conserving battery resources and reducing network resource consumption.

In a further embodiment, a computer program product is provided that includes at least one tangible computer-readable storage medium having computer-readable program code portions stored therein that include program code instructions for determining a privacy filter and content selection rules associated with an earpiece. The computer-readable program code portions may also include program code instructions for causing content to be provided to the earpiece in accordance with the privacy filter and the content selection rules for storage by the earpiece. In this regard, content may be caused to be provided in advance of playback by the earpiece so as to allow for storage of the content by the earpiece. The computer-readable program code portions may also include program code instructions for causing control signals to be subsequently provided to the earpiece during playback.

In yet another embodiment, an apparatus is provided that includes means for determining a privacy filter and content selection rules associated with an earpiece. The apparatus may also include means for causing content to be provided to the earpiece in accordance with the privacy filter and the content selection rules for storage by the earpiece. In this regard, content may be caused to be provided in advance of playback by the earpiece so as to allow for storage of the content by the earpiece. The apparatus may also include means for causing control signals to be subsequently provided to the earpiece during playback.

In one embodiment, a method may be provided that includes causing one or more credentials to be provided to permit an earpiece to be authenticated. In this regard, the earpiece may be associated with a privacy filter and content selection rules. The method of this embodiment may also receive content in accordance with the privacy filter and the content selection rules and may cause the content to be stored by the earpiece. The method of this embodiment may also subsequently cause the content to be retrieved from storage and played back. In one embodiment, the method may also receive control signals from a mobile terminal in order to control playback of the content.

In an instance in which the earpiece is not authenticated, the content that is received in accordance with the privacy filter may include public content, but not private content. Conversely, in an instance in which the earpiece is authenticated, the content that is received by the earpiece may include both public and private content. In one embodiment, the method may also include causing a command instructing the mobile device to suspend a connection with the earpiece to be sent following receipt of the content and prior to playback of the content, thereby conserving battery consumption and network resource consumption.

In another embodiment, an apparatus is provided that includes at least one processor and at least one memory including computer program code configured to, with the at least one processor, cause the apparatus to cause one or more credentials to be provided to permit an earpiece to be authenticated. In this regard, the earpiece may be associated with a privacy filter and content selection rules. The memory including the computer program product of one embodiment may also include computer program code that is configured to, with the at least one processor, cause the apparatus to receive content in accordance with the privacy filter and the content selection rules and to cause the content to be stored by the earpiece. The memory including the computer program product of one embodiment may also include computer program code that is configured to, with the at least one processor, cause the apparatus to subsequently cause the content to be retrieved from storage and played back. In one embodiment, the memory including the computer program product of one embodiment may also include computer program code that is configured to, with the at least one processor, cause the apparatus to receive control signals from a mobile terminal in order to control playback of the content.

In an instance in which the earpiece is not authenticated, the content that is received in accordance with the privacy filter may include public content, but not private content. Conversely, in an instance in which the earpiece is authenticated, the content that is received by the earpiece may include both public and private content. In one embodiment, the memory including the computer program product of one embodiment may also include computer program code that is configured to, with the at least one processor, cause the apparatus to cause a command instructing the mobile device to suspend a connection with the earpiece to be sent following receipt of the content and prior to playback of the content, thereby conserving battery consumption and network resource consumption.

In a further embodiment, a computer program product is provided that includes at least one tangible computer-readable storage medium having computer-readable program code portions stored therein that include program code instructions for causing one or more credentials to be provided to permit an earpiece to be authenticated. In this regard, the earpiece may be associated with a privacy filter and content selection rules. The computer-readable program code portions may also include program code instructions for receiving content in accordance with the privacy filter and the content selection rules and causing the content to be stored by the earpiece. The computer-readable program code portions may also include program code instructions for subsequently causing the content to be retrieved from storage and played back. In one embodiment, the method may also receive control signals from a mobile terminal in order to control playback of the content.

In yet another embodiment, an apparatus may be provided that includes means for causing one or more credentials to be provided to permit an earpiece to be authenticated. In this regard, the earpiece may be associated with a privacy filter and content selection rules. The apparatus of this embodiment may also include means for receiving content in accordance with the privacy filter and the content selection rules and means for causing the content to be stored by the earpiece. The apparatus of this embodiment may also include means for subsequently causing the content to be retrieved from storage and played back. In one embodiment, the apparatus may also include means for receiving control signals from a mobile terminal in order to control playback of the content.

### BRIEF DESCRIPTION OF THE DRAWINGS

Having thus described example embodiments of the present invention in general terms, reference will now be made to the accompanying drawings, which are not necessarily drawn to scale, and wherein:

FIG. 1 is an overview of a system in accordance with an example embodiment to the present invention which includes a mobile terminal for selectively providing content and a pair of earpieces for receiving and playing back the content;

FIG. 2 is a block diagram of an apparatus that may function as either a mobile terminal or an earpiece in accordance with an example embodiment to the present invention;

FIG. 3 is a flowchart illustrating the operations performed from the perspective of a mobile terminal in accordance with an example embodiment to the present invention; and

FIG. 4 is a flowchart illustrating the operations performed from the perspective of a earpiece in accordance with an example embodiment to the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

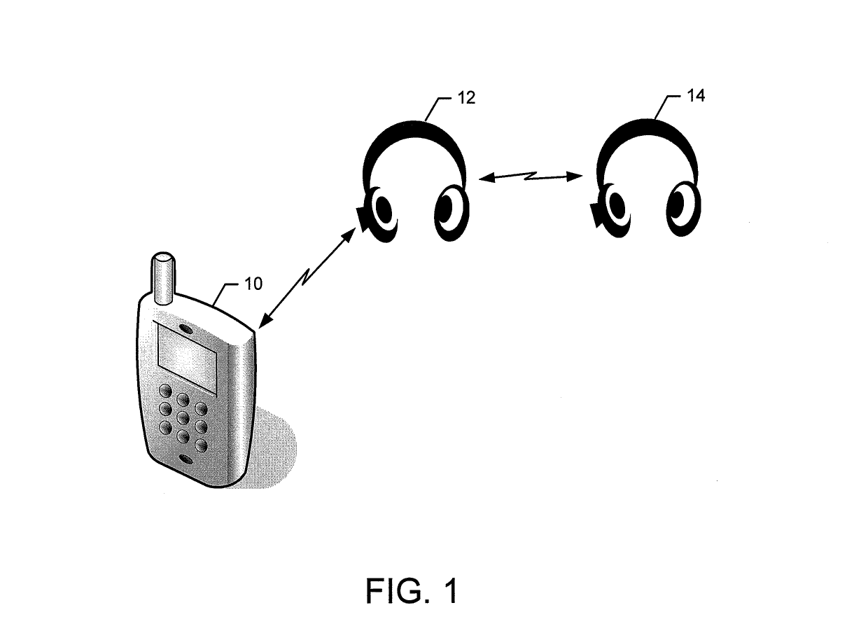

A system in accordance with an example embodiment to the present invention is depicted in FIG. 1. As shown, the system may include a mobile terminal 10 or other content source device for providing content to one or more receiving devices. The system also includes at least one earpiece 12 for receiving and rendering the content. As shown in FIG. 1, the system may optionally include additional earpieces 14 that may also receive and playback the content in at least some instances. The content source device, such as the mobile terminal 10, and a first earpiece 12 may be in communication with one another via a connection, such as a wired or wireless connection. In regards to a wireless connection, the mobile terminal 10 and the first earpiece 12 may communicate in accordance with a number of different types of wireless connections including those provided by Bluetooth, WiFi, worldwide interoperability for microwave access (WiMAX), Zigbee, a wireless local area network (WLAN), radio frequency (RF) memory tags including both standalone RF memory tags or embedded RF memory tags (etags) that are embedded within a mobile terminal or an accessory, a cellular network or the like. The content that may be provided by the content source device, such as the mobile terminal 10, to the earpiece 12 may be any of a variety of different types of content that may be stored and subsequently played back by the earpiece. In an example embodiment, however, the content may include audio content, such as music, books on tape, podcasts or the like.

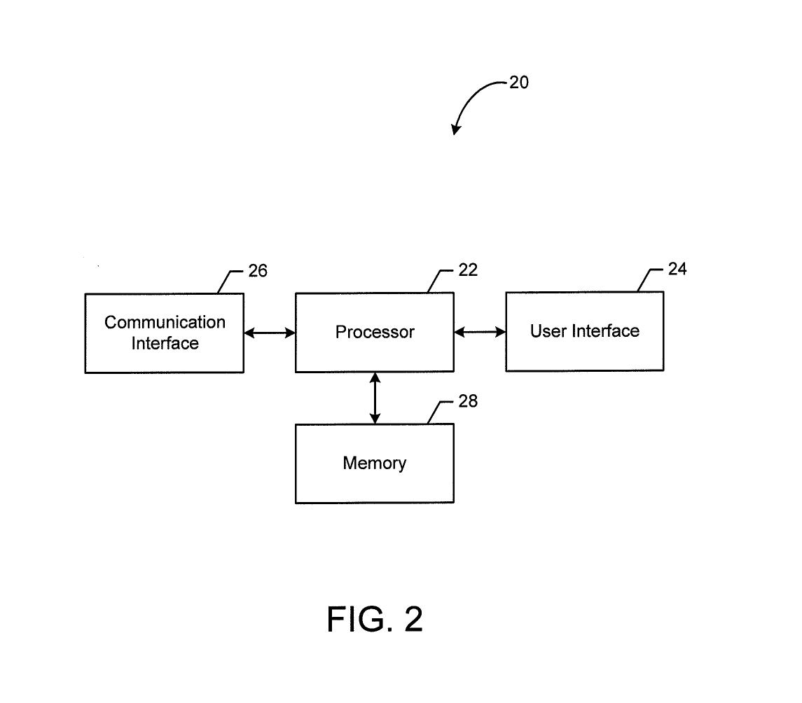

An example embodiment of the invention will now be described with reference to FIG. 2, in which certain elements of an apparatus 20 for downloading content from a content source device, such as a mobile terminal 10, to an earpiece 12, are depicted. The apparatus 20 of FIG. 2 may be employed, for example, in conjunction with either the mobile terminal 10 or either of the earpieces 12, 14 of FIG. 1.

It should also be noted that while FIG. 2 illustrates one example of a configuration of an apparatus 20 for providing for the download of content from a content source device, such as a mobile terminal 10, to an earpiece 12, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 20 for providing for the download of content from a content source device, such as a mobile terminal 10, to an earpiece 12 is provided and may include or otherwise be in communication with a processor 22, a user interface 24, a communication interface 26 and a memory device 28. In some embodiments, the processor 22, and/or co-processors or any other processing circuitry assisting or otherwise associated with the processor 22, may be in communication with the memory device 28 via a bus for passing information among components of the apparatus 20. The memory device 28 may include, for example, one or more volatile and/or non-volatile memories. In other words, for example, the memory device 28 may be an electronic storage device, e.g., a computer readable storage medium, comprising gates configured to store data, e.g., bits, that may be retrievable by a machine, e.g., a computing device like the processor 22. The memory device 28 may be configured to store information, data, applications, instructions or the like for enabling the apparatus to carry out various functions in accordance with an example embodiment of the present invention. For example, the memory device 28 could be configured to buffer input data for processing by the processor 22. Additionally or alternatively, the memory device 28 could be configured to store instructions for execution by the processor 22.

The apparatus 20 may, in some embodiments, be a mobile terminal, e.g., mobile terminal 10, or a fixed communication device or computing device configured to employ an example embodiment of the present invention. However, in some embodiments, the apparatus 20 may be embodied as a chip or chip set. In other words, the apparatus 20 may comprise one or more physical packages, e.g., chips, including materials, components and/or wires on a structural assembly, e.g., a baseboard. The structural assembly may provide physical strength, conservation of size, and/or limitation of electrical interaction for component circuitry included thereon. The apparatus 20 may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an application specific integrated circuit (ASIC), a field programmable gate array (FPGA), a microcontroller unit (MCU), a hardware accelerator, a special-purpose computer chip, or the like. As such, in some embodiments, the processor 22 may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 28 or otherwise accessible to the processor 22. Alternatively or additionally, the processor 22 may be configured to execute hard coded functionality. As such, whether configured by hardware or software methods, or by a combination thereof, the processor 22 may represent an entity, e.g., physically embodied in circuitry, capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device, e.g., a mobile terminal or other computing device, such as processor 20 of mobile terminal 10 of FIG. 1, adapted for employing an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22.

Meanwhile, the communication interface 26 may be any means such as a device or circuitry embodied in either hardware or a combination of hardware and software that is configured to receive and/or transmit data from/to a network and/or any other device or module in communication with the apparatus 20. In this regard, the communication interface 26 may include, for example, an antenna or multiple antennas and supporting hardware and/or software for enabling communications with a wireless communication network. Additionally or alternatively, the communication interface 26 may include the circuitry for interacting with the antenna(s) to cause transmission of signals via the antenna(s) or to handle receipt of signals received via the antenna(s). In some environments, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms.

The user interface 24 may be in communication with the processor 22 to receive an indication of a user input at the user interface 24 and/or to cause provision of an audible, visual, mechanical or other output to the user. As such, the user interface 24 may include, for example, a keyboard, a mouse, a joystick, a display, a touch screen(s), touch areas, soft keys, a microphone, a speaker, or other input/output mechanisms. Alternatively or additionally, the processor 22 may comprise user interface circuitry configured to control at least some functions of one or more elements of the user interface, such as, for example, a speaker, ringer, microphone, display, and/or the like. The processor 22 and/or user interface circuitry comprising the processor 22 may be configured to control one or more functions of one or more elements of the user interface through computer program instructions, e.g., software and/or firmware, stored on a memory accessible to the processor 22, e.g., memory device 28, and/or the like.

In order to avoid cost and performance issues that may be associated with streaming content for immediate playback by an earpiece or other receiving device, content may be provided in accordance with an example embodiment of the present invention in advance of playback at the earpiece 12. As such, the content may be stored at the earpiece 12 and then played back upon the command of the user. By decoupling the provision of the content and the playback of the content, the content may be provided at a time or in a manner in which the transmission cost associated with the provision of the content is relatively low. Additionally, the storage of the content in advance of playback by the earpiece 12 may prevent unexpected pauses during the playback of the content that might otherwise be attributable to transmission errors since any transmission error could have already been accommodated during the provision of the content in advance of storage and playback of the content.

As described below, content may be provided by a content source device, such as a mobile terminal 10, to an earpiece 12 for storage and subsequent playback by the earpiece. In one embodiment, each of the content source device and the earpiece 12 may include an embedded tag (etag) of a radio frequency (RF) memory tag system. As such, subsequent discussion of the operations of the content source device and the earpiece 12, such as the authentication of the earpiece, the provision of content to the earpiece and the storage of the content by the earpiece for subsequent playback, should be understood to be similarly applicable to the performance of at least some of the same operations by and between the respective etags of the content source device and the earpiece.

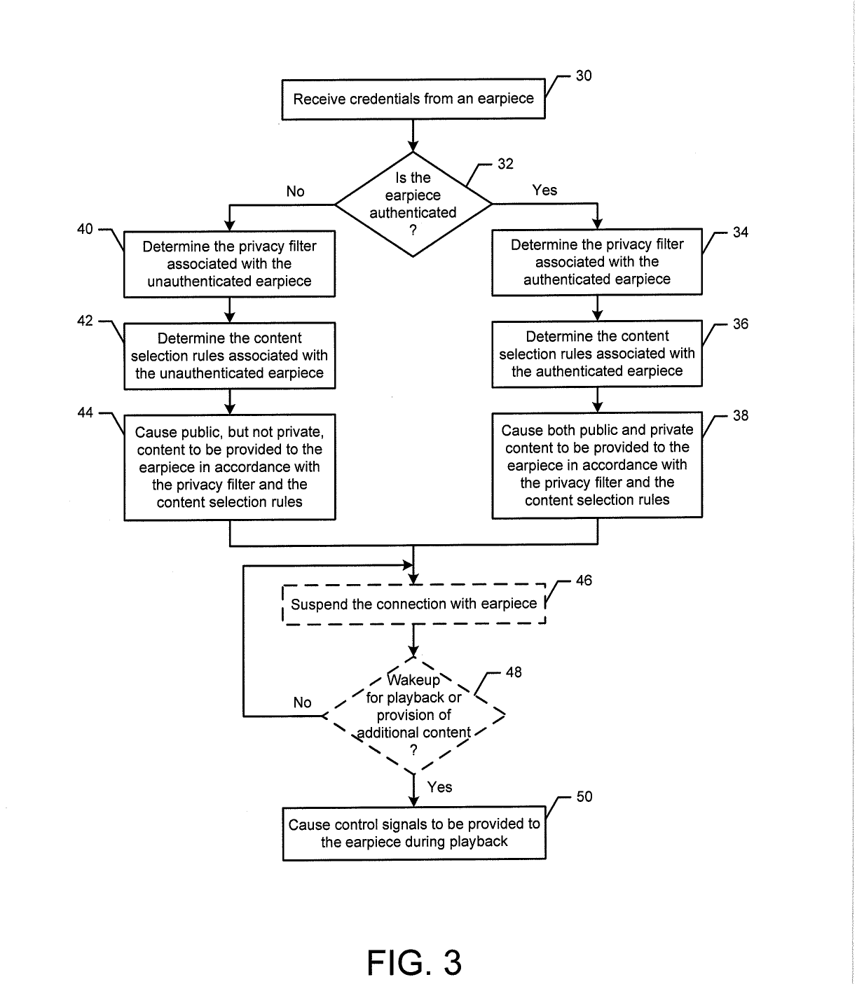

In accordance with an example embodiment to the present invention, content may be provided in accordance with a privacy filter and content selection rules. In one embodiment, the earpiece 12 and the content source device, such as a mobile terminal 10 as referenced below for purposes of illustration but not limitation, may be authenticated which may, in turn, establish the privacy filter and the content selection rules to be applied during the subsequent provision of the content to the earpiece. The mobile terminal 10 and the earpiece 12 may be authenticated in various manners. In one embodiment, however, the earpiece 12 may be brought into proximity with the mobile terminal 10, such as by gently tapping the earpiece and the mobile terminal, such that one or more credentials of the earpiece are provided to the mobile terminal via a connection, such as a wireless connection, that has been established therebetween. Thus, the apparatus 20 embodied by the content source device may include means, such as the processor 22, the communication interface 26 or the like, for receiving the credential(s) from the earpiece as shown in operation 30 of FIG. 3. The mobile terminal 10 may consider the credentials provided by the earpiece 12 and may determine if the earpiece is authenticated. As such, the apparatus 20 embodied by the mobile terminal 10 may include means, such as the processor 22, the memory 28 or the like, for determining if the earpiece is authenticated as shown in operation 32 of FIG. 3. In this process, the mobile terminal 10 may also identify the earpiece 12 based upon the credentials and, as such, may identify the content selection rules associated with the respective earpiece.

The privacy filter may establish the types of content, if any, that may be provided to the earpiece 12 in an instance in which the earpiece is authenticated and in an instance in which the earpiece is not authenticated. As described below, in an instance in which the earpiece 12 is authenticated, the mobile terminal 10 may provide both content that is designated as public content and content that is designated as private content to the respective earpiece. Conversely, in an instance in which the earpiece 12 is not authenticated, the privacy filter may direct that public content still be provided to the earpiece, but not private content. The privacy filter therefore controls the content that is provided to the earpiece 12 based upon whether the earpiece is authenticated or not. The content selection rules may be defined in various manners. In an example embodiment, however, the content selection rules are based upon user preferences and/or historical user behavior. In this regard, the user may provide input, such as to the mobile terminal 10, as to preferred types of content, such as preferred genres of music, preferred artists or the like. Alternatively, the historical behavior of the user may be tracked, such as by the earpiece 12, and provided to the content mobile terminal 10 with the content selection rules being based upon the user's historical behavior. In this regard, the user's historical behavior in terms of the types of content that are most frequently consumed by the user, such as the genre of the songs, the artists of the songs or the like. By controlling the content provided to the earpiece 12 based upon the content selection rules in the manner described below, the content that is most likely to be consumed by the earpiece may be downloaded in advance of playback since it is generally infeasible to download all of the content in advance of playback.

As shown in operations 34 and 36 of FIG. 3, the privacy filter and the content selection rules associated with an earpiece 12 that has been authenticated may be determined. In this regard, the apparatus 20 in the context of a mobile terminal 10 may include means, such as the processor 22 or the like, for determining the privacy filter and the content selection rules. As noted above, in an instance in which the earpiece 12 is authenticated, the privacy filter may direct the both public content and private content associated with the respective earpiece to be provided to the earpiece. As such, the apparatus 20 in the context of the mobile terminal 10 may also include means, such as the processor 22, the communication interface 26 or the like, for causing both public and private content to be provided to the earpiece 12 in accordance with the privacy filter and the content selection rules in an instance in which the earpiece is authenticated. See operation 38 of FIG. 3. As will be noted below, the content may be provided by the mobile terminal 10 in advance of the playback of the content such that the content may be stored by the earpiece 12 for subsequent playback. By controlling the content downloaded to the earpiece 12 in advance of playback in accordance with the content selection rules, the content that will be most likely consumed or more frequently consumed at the earpiece may be provided by the mobile terminal 10 in one embodiment in advance of playback and stored by the earpiece so as to increase the efficiency and effectiveness of the content delivery process.

Conversely, in an instance in which the earpiece is not authenticated, the content source device may determine the privacy filter and content selection rules associated with an earpiece that has not been authenticated. Indeed, the apparatus 20 in the context of a mobile terminal 10 may include means, such as the processor 22, the memory device 28 or the like, for determining the privacy filter and content selection rules associated with an earpiece that has not been authenticated as shown in operations 40 and 42 of FIG. 3. A privacy filter in this instance may indicate that the mobile terminal 10 is to provide no content to the unauthenticated earpiece. However, in some embodiments, the privacy filter associated with an unauthenticated earpiece may indicate that public content is provided in accordance with the content selection rules, but not private content. As such, the apparatus 20 in the context of the mobile terminal 10 may include means, such as the processor 22, communication interface 26 or the like, for causing public, but not private, content to be provided in accordance with the privacy filter and the content selection rules for an earpiece that has not been authenticated but has been identified (thereby allowing identification of the privacy filter and the content selection rules associated with the earpiece). See operation 44.

As described above, in an instance in which the earpiece is identified even though the earpiece is not authenticated, the mobile terminal 10 may provide those types of public content, if permitted by the privacy filter, that are consistent with the content selection rules associated with the earpiece 12. However, in an instance in which the earpiece not only cannot be authenticated, but cannot be identified, the mobile terminal may simply provide the public content to the earpiece, but will be unable to tailor the public content in accordance with the content selection rules since the content selection rules associated with the respective earpiece cannot be identified since the earpiece itself was not identified.

Subsequent to the provision of content to the earpiece 12 and following storage of the content by the earpiece, the content may be played back, such as in response to input by the user requesting playback. Although the user may provide input via the earpiece 12, the user of one embodiment may provide input to the mobile terminal 10, such as via the user interface 24 of the mobile terminal 10. In this embodiment, the mobile terminal 10 may be caused to provide control signals, such as play, stop, fast forward, rewind or the like, to the earpiece 12, such as via the wireless connection, in order to direct the playback of the content that has previously been provided to and stored by the earpiece. As such, the apparatus 20 in the context of the mobile terminal 10 may include means, such as the processor 22, the communication interface 26 or the like, for causing control signals to be provided to the earpiece 12 during playback of the content.

In some embodiments, certain ones of the operations above may be modified or further amplified as described below. Moreover, in some embodiments additional optional operations may also be included; some examples of which are shown in dashed lines in FIG. 3. It should be appreciated that each of the modifications, optional additions or amplifications below may be included with the operations above either alone or in combination with any others among the features described herein. In this regard, the mobile terminal 10 of an example embodiment may optionally have the connection with the earpiece 12 temporarily suspended following the provision of the content to the earpiece and prior to the playback of the content. By suspending the connection, the mobile terminal may conserve battery resources and reduce network resource consumption. The mobile terminal 10 may be caused to suspend the connection for various reasons. For example, the mobile terminal 10 may cause the connection with the earpiece to be suspended in response to completion of the delivery of content to the earpiece 12, assuming that the mobile terminal has not yet received any instruction directing the playback of the content. Alternatively, the earpiece 12 may be configured to provide a control signal to the mobile terminal 10 following the delivery of the content to the earpiece and the storage of the content by the earpiece indicating that the connection between the mobile terminal and the earpiece may be suspended. In any instance, the apparatus 20 in the context of the mobile terminal 10 may include means, such as the processor 22, the communication interface 26 or the like, for temporarily suspending the connection with the earpiece 12, as shown in operation 46 of FIG. 3.

In an instance in which the connection is suspended, the mobile terminal 10 may periodically reestablish the connection to determine if any command or other instructions have been received from the earpiece 12 to cause the connection to be reopened. Additionally, the mobile terminal may consider user inputs to its user interface and reopen the connection in an instance in which the user inputs indicate that the connection is to be reestablished, such as in an instance in which the content is to be played back and the mobile terminal 10 is to provide control signals to the earpiece 12 during playback. As such, the apparatus 20 in the context of the mobile terminal 10 may include means, such as the processor 22 or the like, for determining whether the mobile terminal should wake up, such as for playback or the provision of additional content, as shown in block 48 of FIG. 3.

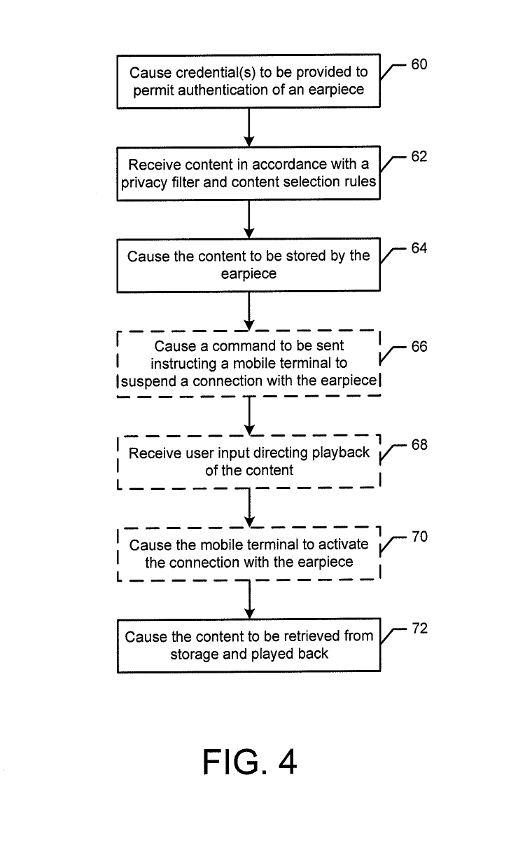

From the perspective of the earpiece 12 and in regards to FIG. 4, the earpiece may initially be considered for authentication by a content source device, such as the mobile terminal 10 as described below for purposes of illustration but not of limitation. In this regard, the earpiece 12 may cause one or more credentials to be provided to the mobile terminal 10 to permit authentication of the earpiece. As such, the apparatus 20 in the context of the earpiece 12 may include means, such as the processor 22, the communication interface 26, the memory 28 or the like, for causing credential(s) to be provided to permit authentication of the earpiece as shown in operation 60 of FIG. 4. As described above, the earpiece 12 may provide the credentials in various manners, such as by establishing a connection, such as a wireless connection, with the mobile terminal 10 and then being placed in proximity to the mobile terminal, such as by being tapped against the mobile terminal, which may, in turn, trigger the credentials of the earpiece to be provided to the mobile terminal. Based upon the credentials, the mobile terminal 10 may determine whether the earpiece 12 is authenticated and may determine the identity of the earpiece such that a privacy filter and content selection rules may be appropriately identified. As such, the earpiece 12 may then receive content in accordance with the privacy filter and the content selection rules, as shown in operation 62 of FIG. 4. In this regard, the apparatus 20 in the content of an earpiece 12 may include means, such as the processor 22, the communication interface 26 or the like, for receiving the content from the mobile terminal 10. For example, in an instance in which the earpiece 12 has been authenticated, the earpiece may receive both public and private content that is tailored in accordance with content selection rules. Alternatively, in an instance in which the earpiece 12 is not authenticated, the earpiece may receive public content, but not private content in accordance with the content selection rules.

As shown in operation 64 of FIG. 4, the earpiece 12 may then cause the content to be stored, such as in memory 28, for later recall and playback. As such, the apparatus 20 in the content of an earpiece 12 may include means, such as the processor 22, the memory 28 or the like, for storing the content from the mobile terminal 10. By storing the content at the earpiece 12 in advance of playback, however, any errors that arise during the transmission may be resolved and the content that is stored may be free of those errors such that the playback of the content will not experience unexpected pauses attributable to transmission errors. Thereafter, the user may direct playback of the content and the earpiece 12 may, in turn, cause the content to be retrieved from storage and played back as shown in operation 72 of FIG. 4. As such, the apparatus 20 in the content of an earpiece 12 may include means, such as the processor 22, the user interface 24, the memory 28 or the like, for causing the content to be retrieved from storage and played back. During playback of the content, the earpiece 12 may receive control signals from the mobile terminal 10 that may control or direct the playback of the content, such as by directing that the content be played, stopped, paused, rewound, fast forwarded or the like.

As noted above in conjunction with FIG. 3, certain ones of the operations above may be modified or further amplified and/or additional optional operations may also be included; some examples of which are shown in dashed lines in FIG. 4. It should be appreciated that each of the modifications, optional additions or amplifications below may be included with the operations above either alone or in combination with any others among the features described herein. In this regard and as described above in conjunction with the mobile terminal 10, the connection between the mobile terminal and the earpiece 12 may be optionally suspended following the provision and storage of the content and prior to playback of the content. Although the mobile terminal 10 may suspend the connection on its own initiative as described above, the earpiece 12 of one example embodiment may optionally cause a command to be sent to the mobile terminal following downloading of the content and prior to playback of the content that instructs the mobile terminal to suspend the connection with the earpiece. In this regard, the apparatus 20 in the context of earpiece 12 may cause a command to be sent instructing the mobile terminal 10 to suspend the connection with the earpiece, as shown in operation 66 of FIG. 4.

Subsequently, the connection may be reestablished, such as in response to a user input directing playback of the content. As described above, the user may provide input regarding the playback of the content via the user interface of the mobile terminal 10 with the mobile terminal then reestablishing the connection with the earpiece 12. Alternatively, the user may provide input regarding playback of the content via a user interface of the earpiece 12. For example, the apparatus 20 in the context of the earpiece 12 may include means, such as the processor 22, the user interface 24 or the like, for receiving user input directing playback of the content. In this instance, the earpiece 12 may be configured to receive the user input regarding playback of the content and to then cause the mobile terminal 10 to activate or otherwise reestablish the connection with the earpiece so as to allow the mobile terminal to provide control signals during the playback of the content. See operations 68 and 70 of FIG. 4. As such, the apparatus 20 in the context of the earpiece 12 may include means, such as the processor 22, the user interface 24 or the like, for causing the mobile terminal 10 to activate the connection with the earpiece.

The earpiece 12 may track the content that is played back by the user in order to establish and/or update the content selection rules. In this regard, the content selection rules may be based upon the user's historical behavior such that the content that is played back by the earpiece may be utilized to define or redefine the content selection rules. As such, the information collected by the earpiece 12 regarding the content that is played back may be provided to the mobile terminal 10 in one embodiment for review and for updating of the content selection rules.

As shown in FIG. 1, the system may include one or more second or additional earpiece(s) 14. These additional earpieces 14 may also be configured to download and store content for subsequent playback. Although the mobile terminal 10 may separately and independently communicate with the plurality of earpieces 12, 14 and selectively provide content to the respective earpieces in the manner described above, the earpieces may be in communication with one another, such as via a wireless link established therebetween, such that the first earpiece 12 may provide at least some of the content that has been received and stored by the first earpiece to an additional earpiece 14. As described above in regards to the download of content from the mobile terminal 10 to the first earpiece 12, the first earpiece and an additional earpiece 14 may initially be authenticated, such as by bringing the additional earpiece in proximity to the first earpiece such that one or more credentials of the additional earpiece are provided to the first earpiece. The first earpiece 12 may determine if the additional earpiece 14 is authenticated, such as by comparing the credentials to a list of predefined authenticated earpieces. The first earpiece 12 may then determine the privacy filter and content selection rules associated with the additional earpiece 14 based upon whether the additional earpiece is authenticated or not.

The first earpiece 12 may then cause content to be provided to the additional earpiece 14 in accordance with the privacy filter and the content selection rules. As described above, in an instance in which the additional earpiece 14 is authenticated, the first earpiece 12 may cause both public and private content to be provided in accordance with the content selection rules. Alternatively, in an instance in which the additional earpiece 14 is not authenticated, the first earpiece 12 may cause only the public content and not the private content to be provided. In at least some embodiments, the content that is provided to the additional earpiece 14 may be marked in such a manner as to control the access privileges provided to the additional earpiece such that the content may be played back by the additional earpiece, but may not be forwarded to still other earpieces. As described above, the additional earpiece 14 may store the content and the connection between the earpieces 12, 14 may be suspended so as to consume battery resources. Thereafter, in response to a user input requesting playback of the content, such as receive via user interface of the second earpiece 14, the connection may be reestablished or reactivated and control signals may be provided from the first earpiece 12 and/or the mobile terminal 10 to the other earpiece in order to control the playback of the content.

As described above, FIGS. 3 and 4 are flowcharts of a method and program product according to an example embodiment of the invention. It will be understood that each block of the flowcharts, and combination of blocks in the flowcharts, may be implemented by various means, such as hardware, firmware, processor, circuitry and/or other device associated with execution of software including one or more computer program instructions. For example, one or more procedures described above may be embodied by computer program instructions. In this regard, the computer program instructions which embody the procedures described above in conjunction with one embodiment may be stored by a memory device 28 of a mobile terminal 10 and executed by a processor 22 in the mobile terminal. However, the computer program instructions which embody the procedures described above in conjunction with another embodiment may be stored by a memory device 28 of an earpiece 12 and executed by a processor 22 in the earpiece. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although described above in conjunction with a mobile terminal 10, other types of content source devices may provide content to the earpiece 12 in the manner described above. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining a privacy filter associated with an earpiece;
determining content selection rules associated with the earpiece;
causing content to be provided to the earpiece in accordance with the privacy filter and the content selection rules for storage by the earpiece; and
causing control signals to be subsequently provided to the earpiece during playback.

2. A method according to claim 1 further comprising authenticating the earpiece prior to determining the privacy filter and the content selection rules.

3. A method according to claim 2 wherein determining the privacy filter comprises determining the privacy filter to allow provision of public content, but not private content, to the earpiece in an instance in which the earpiece is not authenticated.

4. A method according to claim 1 further comprising suspending a connection with the earpiece following provision of the content to the earpiece.

5. A method according to claim 1 wherein causing content to be provided comprises causing content to be provided in advance of playback by the earpiece.

6. A computer program product comprising at least one non-transitory computer-readable storage medium having computer-readable program code portions stored therein, the computer-readable program code portions, upon execution, being configured to cause an apparatus to perform the method of claim 1.

7. An apparatus comprising:
at least one processor; and
at least one memory including computer program code configured to, with the at least one processor, cause the apparatus to perform at least the following:
determine a privacy filter associated with an earpiece;
determine content selection rules associated with the earpiece;
cause content to be provided to the earpiece in accordance with the privacy filter and the content selection rules for storage by the earpiece; and
cause control signals to be subsequently provided to the earpiece during playback.

8. An apparatus according to claim 7 wherein the at least one memory including computer program code is further configured to, with the at least one processor, cause the apparatus to authenticate the earpiece prior to determining the privacy filter and the content selection rules.

9. An apparatus according to claim 8 wherein the at least one memory including computer program code is configured to, with the at least one processor, cause the apparatus to determine the privacy filter by determining the privacy filter to allow provision of public content, but not private content, to the earpiece in an instance in which the earpiece is not authenticated.

10. An apparatus according to claim 7 wherein the at least one memory including computer program code is further configured to, with the at least one processor, cause the apparatus to suspend a connection with the earpiece following provision of the content to the earpiece.

11. An apparatus according to claim 1 wherein the at least one memory including computer program code is configured to, with the at least one processor, cause the apparatus to cause content to be provided by causing content to be provided in advance of playback by the earpiece.

12. A method comprising:
causing one or more credentials to be provided to permit an earpiece to be authenticated, wherein the earpiece is associated with a privacy filter and content selection rules;
receiving content in accordance with the privacy filter and the content selection rules;
causing the content to be stored by the earpiece; and
subsequently causing the content to be retrieved from storage and played back.

13. A method according to claim 12 further comprising receiving control signals from a mobile terminal in order to control playback of the content.

14. A method according to claim 12 wherein receiving content in accordance with the privacy filter comprises receiving public content, but not private content, in an instance in which the earpiece is not authenticated.

15. A method according to claim 12 further comprising causing a command instructing a mobile terminal to suspend a connection with the earpiece to be sent following receipt of the content and prior to playback of the content.

16. A computer program product comprising at least one non-transitory computer-readable storage medium having computer-readable program code portions stored therein, the computer-readable program code portions, upon execution, being configured to cause an apparatus to perform the method of claim 12.

17. An apparatus comprising:
at least one processor; and
at least one memory including computer program code configured to, with the at least one processor, cause the apparatus to perform at least the following:
cause one or more credentials to be provided to permit an earpiece to be authenticated, wherein the earpiece is associated with a privacy filter and content selection rules;
receive content in accordance with the privacy filter and the content selection rules;
cause the content to be stored by the earpiece; and
subsequently cause the content to be retrieved from storage and played back.

18. An apparatus according to claim 17 wherein the at least one memory including computer program code is further configured to, with the at least one processor, cause the apparatus to receive control signals from a mobile terminal in order to control playback of the content.

19. An apparatus according to claim 17 wherein the at least one memory including computer program code is configured to, with the at least one processor, cause the apparatus to receive content in accordance with the privacy filter by receiving public content, but not private content, in an instance in which the earpiece is not authenticated.

20. An apparatus according to claim 17 wherein the at least one memory including computer program code is further configured to, with the at least one processor, cause the apparatus to cause a command instructing a mobile terminal to suspend a connection with the earpiece to be sent following receipt of the content and prior to playback of the content.
